(19) United States
(12) Patent Application Publication
(10) Pub. No.: US 2024/0302799 A1
(43) Pub. Date: Sep. 12, 2024

(54) DEVICE CASE AND TIMEPIECE

(71) Applicant: CASIO COMPUTER CO., LTD., Tokyo (JP)

(72) Inventors: Yoshihiro MARUYAMA, Tokyo (JP); Masao AMANO, Tokyo (JP)

(73) Assignee: CASIO COMPUTER CO., LTD., Tokyo (JP)

(21) Appl. No.: 18/599,950

(22) Filed: Mar. 8, 2024

(30) Foreign Application Priority Data
Mar. 8, 2023 (JP) 2023-035173

(51) Int. Cl. G04B 43/00

(52) U.S. Cl. CPC G04B 43/002

(57) ABSTRACT

Disclosed is a device case including: a first exterior that is placed on an upper surface side of a case body; a second exterior that covers at least an upper portion of the first exterior; and a first position buffer as a buffer disposed between the first exterior and the second exterior. The first exterior includes an inclined surface on an upper surface side, and the first position buffer is disposed on the inclined surface of the first exterior.

### REFERENCE TO RELATED APPLICATIONS

This application is based upon and claims the benefit of priority from the prior Japanese Patent Application No. 2023-035173, filed on Mar. 8, 2023, the entire contents of which are incorporated herein by reference.

### TECHNICAL FIELD

The present disclosure relates to a device case and a timepiece.

### DESCRIPTION OF RELATED ART

Conventionally, device cases with first exteriors and second exteriors are known. For example, JP 2016-153724 A describes a configuration in which a second exterior (for example, a bezel, and the like) formed of a metallic material, and the like, are provided around the upper circumference of the first exterior provided on the device case.

### SUMMARY OF THE INVENTION

According to an aspect of the present disclosure, there is provided a device case including: a first exterior that is placed on an upper surface side of a case body; a second exterior that covers at least an upper portion of the first exterior; and a first position buffer as a buffer disposed between the first exterior and the second exterior. The first exterior includes an inclined surface on an upper surface side, and the first position buffer is disposed on the inclined surface of the first exterior.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view of a timepiece in an embodiment;

FIG. 2 is a main part diagram showing main parts of the timepiece shown in FIG. 1, omitting a display and operation receivers;

FIG. 3 is a main part exploded diagrammatic view of the timepiece in the state shown in FIG. 2;

FIG. 4 is a cross-sectional view along the IV-IV line in FIG. 1;

FIG. 5 is a main part enlarged diagrammatic view of the timepiece on the 3 o'clock side;

FIG. 6 is a main part enlarged diagrammatic view of the timepiece on the 9 o'clock side;

FIG. 7 is a cross-sectional view along the VII-VII line in FIG. 1;

FIG. 8 is a cross-sectional view along the VIII-VIII line in FIG. 1;

FIG. 9A is a top view of an example of a buffer with protrusions;

FIG. 9B is a side view of the example of the buffer with the protrusions; and

FIG. 10 is a top view of an example of an annular buffer with protrusions.

### DETAILED DESCRIPTION

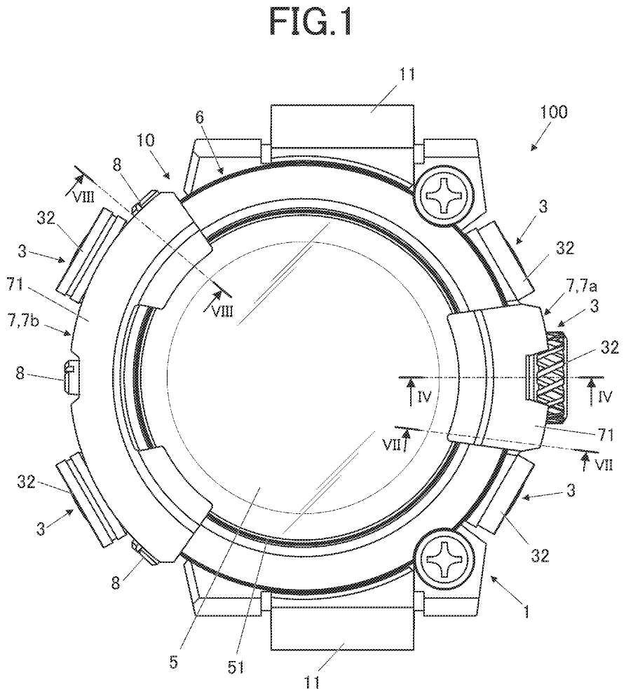

With reference to FIGS. 1 to 8, one embodiment of a device case and a timepiece including the device case according to the present disclosure will be described. The present embodiment illustrates a case in which the device case is a case of a timepiece (wristwatch).

The embodiments described below are subject to various technically preferred limitations for implementing the present disclosure, but the scope of the present disclosure is not limited to the following embodiments and illustrated examples.

### [Configuration]

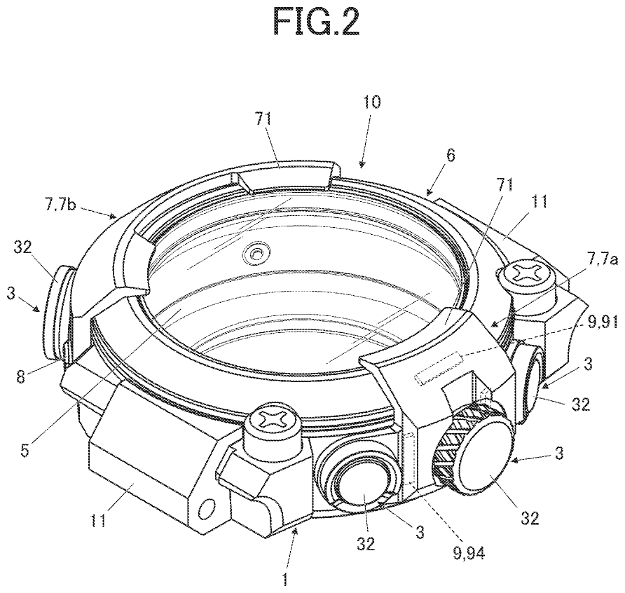

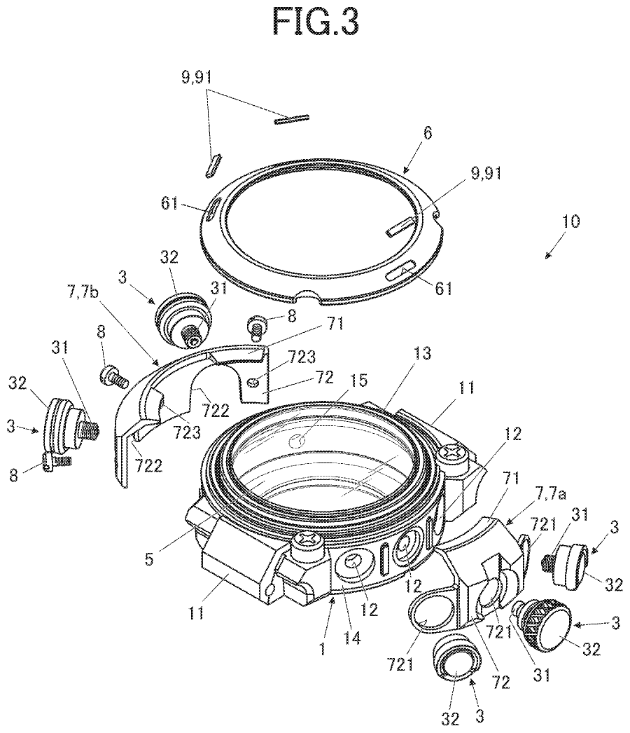

FIG. 1 is a front view of the timepiece in the present embodiment. FIG. 2 is a main part diagram of the main parts of the timepiece shown in FIG. 1. FIG. 3 is a main part exploded diagrammatic view in the present embodiment. FIG. 4 is a main part cross-sectional view along the IV-IV line in FIG. 1. In FIGS. 1 to 3, the display of the timepiece 100 and other various components housed inside the device case 10 are omitted.

Conventionally, in device cases of timepieces and the like, a luxurious appearance can be achieved by attaching an exterior made of metal and the like to the case body. However, when the case body to which the exterior is attached is also made of metal, there is a risk that the metal may come into contact with each other, resulting in damage to both of them.

The following is a description of a device case and a timepiece designed to remedy this situation and prevent damage.

As shown in FIGS. 1 to 4, the timepiece 100 in the present embodiment has a device case 10. The device case 10 includes a case body 1.

The case body 1 is formed of a metallic material such as titanium, stainless steel (SUS), or aluminum, for example. The materials that make up the case body 1 are not limited to those illustrated here.

The case body 1 of the present embodiment is formed in the shape of a hollow short column with openings at the top and bottom in the direction of the thickness of the timepiece 100. The hollow portion inside houses various components such as a module 2 (shown in single dotted lines in FIGS. 4, 7, and 8).

The specific configuration of the module 2 is not described in detail, but when the timepiece 100 is an electronic timepiece, various operating parts of the timepiece 100, a controller that controls these parts, a battery, and the like are included in the module 2.

The timepiece 100 may include an analog-type display with hands, and the like, not shown, or a digital-type display with, for example, a liquid crystal display.

For example, if the timepiece 100 is an analog display system, the timepiece 100 has hands, a gear train (wheel mechanism) that rotates the hands, and a driver (motor, and the like), and the like as the operating parts. If the timepiece 100 is a digital display system, the timepiece 100 includes, as the operating parts, a display and the like including a liquid crystal display panel instead of each of the above components, and the display is disposed on the front side (visible side) of the timepiece. The timepiece 100 may be a hybrid type having both digital and analog systems, in which case the timepiece 100 has both components as operating parts.

The controller is mounted on a circuit board, and the like, not shown in the drawings, and controls the display operation, and the like, by the operating parts.

On the outer side surface of the case body 1, on the 12 o'clock and 6 o'clock sides of the timepiece (that is, at the top and bottom ends in FIG. 1), there are band attachment portions 11 where the timepiece band, not shown, is attached.

In addition, various operation receivers 3 (pushbuttons, crowns, and the like) for the user to perform various input operations are provided on the outside of the device case 10 and the like. The operation receiver 3 includes a shaft 31 that is inserted into the case body 1 of the device case 10, and an operation head 32 that is attached to one end of the shaft 31 and placed outside the case body 1.

In the present embodiment, a through hole 12 for inserting the shaft 31 corresponding to the position of each of the operation receivers 3 is formed in the side of the case body 1. The shaft 31 is inserted into the through hole 12 from the outside of the case body 1 toward the inside, and at least the tip of the shaft 31 contacts the module 2 in the case body 1 to act on the module 2. The operation head 32 is a user-operable portion, and various operations can be performed by pushing or rotating the operation head 32. The arrangement, number, shape, and the like of the operation receivers 3 are not limited to the illustrated example.

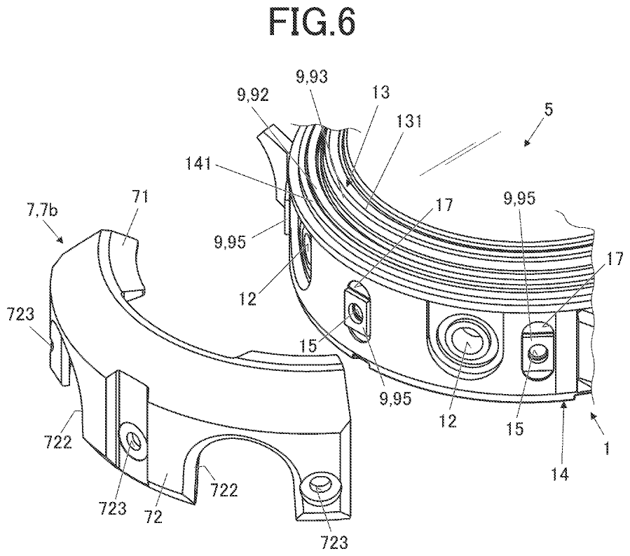

On the lower side of the case body 1 (back side of the timepiece 100), there is a back cover member 4 (see FIG. 6, and the like) that closes the opening on the back side. The case body 1 and the back cover member 4 may be molded as a single piece, with no opening on the lower side of the case body 1.

The upper (visible side, front side of the timepiece) opening end of the case body 1 has a rising neck 13 that is smaller in diameter than the lower portion. In other words, the case body 1 includes a cylindrical portion 14 and the rising neck 13 that is formed on the upper side of the cylindrical portion 14 (the visible side, the front side of the timepiece) and rises continuously upward on the inner diameter side.

As shown in FIG. 4, and the like, the outer circumferential surface of the rising neck 13 (rising surface 131) and the upper end surface 141 of the cylindrical portion 14 are approximately L-shaped in cross-section.

Inside the rising neck 13, a windshield member 5 is attached via a waterproof ring 51 and the like. By interposing the waterproof ring 51 and the like between the opening of the case body 1 and the windshield member 5, the upper opening of the case body 1 is closed with airtightness ensured.

The windshield member 5 is a transparent member (cover member) formed of, for example, glass material or transparent resin material.

A bezel 6 as a first exterior is placed on the upper surface side of the case body 1.

As shown in FIG. 3, and the like, the bezel 6 in the present embodiment is a nearly annular member, disposed to cover the upper end surface of the rising neck 13 and the upper end surface 141 of the cylindrical portion 14.

The bezel 6 is formed of a metallic material such as titanium, stainless steel (SUS), or aluminum, for example. The materials that make up the bezel 6 are not limited to those illustrated here. The bezel 6 may be formed of the same material as the case body 1 or different materials.

The device case 10 also includes a guard member 7 as a second exterior that covers from the upper portion of the bezel 6 as the first exterior to the outer circumferential side surface of the case body 1.

The guard member 7 is formed of a metallic material such as titanium, stainless steel (SUS), or aluminum, for example. The materials that make up the guard member 7 are not limited to those illustrated here. The guard member 7 may be formed of the same material as the bezel 6, and the like, or of different materials.

The guard member 7 covers from the upper portion of the bezel 6 to the outer circumferential side surface of the case body 1 on at least part of the circumferential surface of the case body 1. In the present embodiment, the guard member 7 is disposed on the 3 o'clock and 9 o'clock sides on the timepiece, corresponding to the portions where the operation receivers 3 are provided. In other words, the device case 10 of the present embodiment has the guard member 7 (this is referred to as a first guard member 7a) disposed on the 3 o'clock side of the timepiece 100 and the guard member 7 (this is referred to as a second guard member 7b) disposed on the 9 o'clock side of the timepiece 100. When simply referred to as guard member(s) 7 hereinafter, both the first guard member 7a and the second guard member 7b are included. The scope, arrangement, number, shape, and the like of the guard members 7 are not limited to the illustrated examples.

Each guard member 7 has an upper surface portion 71 covering the upper portion of the bezel 6 and a side surface portion 72 covering the outer circumferential side surface of the case body 1. The bezel 6 has on its upper surface a flat portion that is nearly parallel to the display surface of the timepiece and an inclined portion that is inclined at a predetermined angle to the display surface of the timepiece. The guard member 7 has a flat portion disposed on the flat portion that is the uppermost surface of the bezel 6, and an inclined portion disposed on the inclined portion of the bezel 6.

As shown in FIGS. 3 and 4, and the like, a recess 61 is formed in each portion that is the inclined portion located on the upper surface of the bezel 6 and contacting the guard member 7, and a buffer 9 is disposed within this recess 61. The buffer 9 (first position buffer) disposed in the recess 61 of the inclined portion located on the upper surface of the bezel 6 is referred to as a first buffer 91. The first buffer 91 which is the first position buffer is formed, for example, of fluorinated rubber. The material for forming the first buffer 91 is not limited to this.

Thus, the first buffer 91 is located between the inclined portion disposed on the upper surface of the bezel 6 and the inclined portion located on the lower surface of the guard member 7. Therefore, even if there is an external shock, the shock can be dispersed in the X and Y directions, which are the directions of the plane of the display surface of the timepiece, and in the Z direction, which is the direction orthogonal to the display surface of the timepiece (thickness direction of the timepiece). If the first buffer 91 is disposed between the flat portion of the upper surface of the bezel 6 and the flat portion of the lower surface of the guard member 7, when there is an external shock, the shock is transmitted only in the Z direction and would not be distributed in the X and Y directions, and the internal module may be affected by the shock.

In the present embodiment, as shown in FIG. 3, one first buffer 91 is provided corresponding to the first guard member 7a and two first buffers 91 are provided corresponding to the second guard member 7b.

The method of fixing the first buffer 91 is not particularly limited, but may be, for example, by double-sided tape 101. The first buffer 91 itself may be provided with an adhesive surface so that it can be affixed and fixed to an object simply by peeling off a release paper and the like protecting the adhesive surface.

The buffers between the bezel 6 and the case body 1 are separated into a second buffer 92 disposed on the lower side of the bezel 6 and a third buffer 93 disposed on the lateral side of the bezel 6, and are disposed apart from each other, allowing the material and hardness to be changed. If the second buffer 92 and the third buffer 93 are integrated from the lower side of the bezel 6 to the lateral side, it is not possible to change the material and hardness.

The position, range, size, shape, and the like of the first buffer 91 are not limited to the illustrated example. For example, two first buffers 91 may be provided between the first guard member 7a and the bezel 6 corresponding to the first guard member 7a.

The place to house the first buffer 91 is not limited to the recess 61 formed in the upper surface of the bezel 6. At least part of the first buffer 91 is preferably housed in a recess formed in at least one of the bezel 6, which is the first exterior or the guard member 7, which is the second exterior. For example, the guard member 7 side may have a recess formed in which at least part of the first buffer 91 is housed. Also, a recess having thickness of half the thickness of the first buffer 91 or less may be provided at corresponding positions of both the bezel 6 and the guard member 7, so that the first buffer 91 is sandwiched within both recesses.

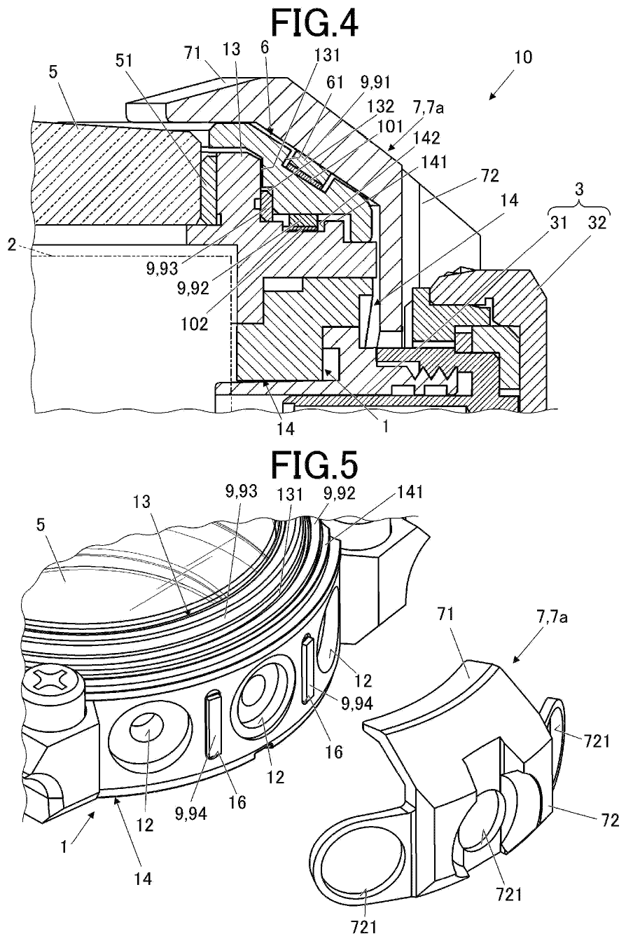

The side surface portion 72 of each guard member 7 is provided with a hole 721 (see FIGS. 3 and 5) or a cut portion 722 (see FIGS. 3 and 6) in the portion corresponding to the operation receiver 3. Whether a hole or a cut portion is provided in the portion corresponding to the operation receiver 3 is not particularly limited, and a hole may be provided for any of the guard members 7 or a cut portion may be provided for any of the guard members 7.

FIG. 5 is a main part enlarged diagram enlarging the 3 o'clock side in the timepiece. FIG. 6 is a main part enlarged diagram enlarging the 9 o'clock side in the timepiece. In FIGS. 5 and 6, illustration of the bezel 6 is omitted.

In the present embodiment, as shown in FIG. 1, and the like, three operation receivers 3 are provided on the 3 o'clock side of the timepiece, and as mentioned above, the through holes 12 are formed on the side surface on the 3 o'clock side of the case body 1 to insert these operation receivers 3.

As shown in FIGS. 3 and 5, the guard member 7 (first guard member 7a) disposed on the 3 o'clock side has holes 721 at respective positions corresponding to the through holes 12 in the case body 1.

The first guard member 7a is fixed to the side surface of the case body 1 by screws, double-sided tape, or other means not shown in the figure. When the first guard member 7a is fixed to the case body 1, the bezel 6 is held from above by the upper surface portion 71, and the bezel 6 which is the first exterior is held between the case body 1 and the first guard member 7a (upper surface portion 71 of the first guard member 7a). When the first guard member 7a is fixed with screws, it is preferable to leave a small margin at the joint by the screws, so that the structure can be slightly movable when an external shock is applied.

In the present embodiment, as shown in FIG. 1, and the like, two operation receivers 3 are provided on the 9 o'clock side of the timepiece 1, and as mentioned above, the through holes 12 are formed on the side surface on the 9 o'clock side of the case body 1 to insert these operation receivers 3.

As shown in FIGS. 3 and 6, the guard member 7 (second guard member 7b) disposed on the 9 o'clock side has cut portions 722 at respective positions corresponding to the through holes 12 in the case body 1.

In the side surface portion 72 of the second guard member 7b, screw holes 723 are formed at positions avoiding the cut portions 722. In the side surface of the case body 1, screw holes 15 are formed at positions corresponding to these screw holes 723. The second guard member 7b is screwed to the side surface of the case body 1 by inserting screws 8 into the screw holes 723 and the screw holes 15 from the outside. When the second guard member 7b is fixed to the case body 1, the bezel 6 is held from above by the upper surface portion 71, and the bezel 6 which is the first exterior is held between the case body 1 and the second guard member 7b (upper surface portion 71 of the second guard member 7b). When the second guard member 7b is fixed with screws, it is preferable to leave a small margin at the joint by the screws, so that the structure can be slightly movable when an external shock is applied.

The device case 10 in the present embodiment also has a first buffer 91 as a buffer 9 (first position buffer) between the bezel 6 and the guard member 7, and a buffer 9 (referred to as a second position buffer) disposed at a position different from that of the first buffer 91 that is the first position buffer.

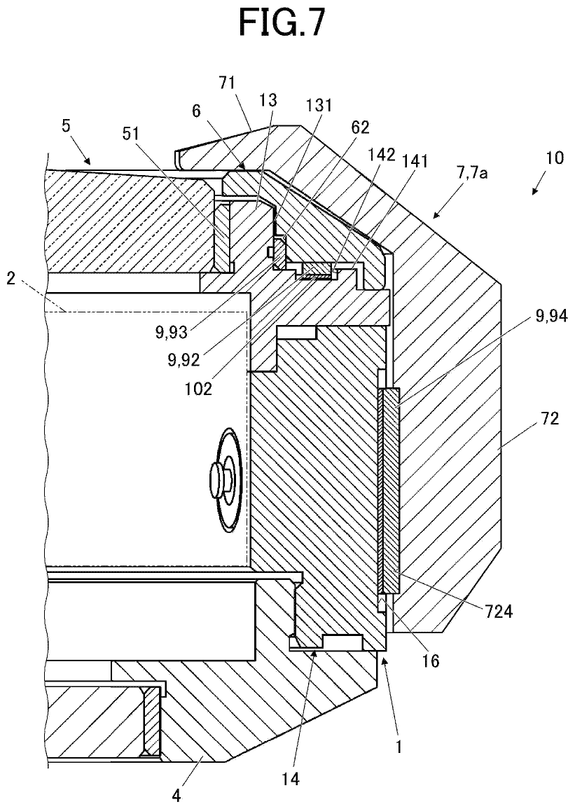

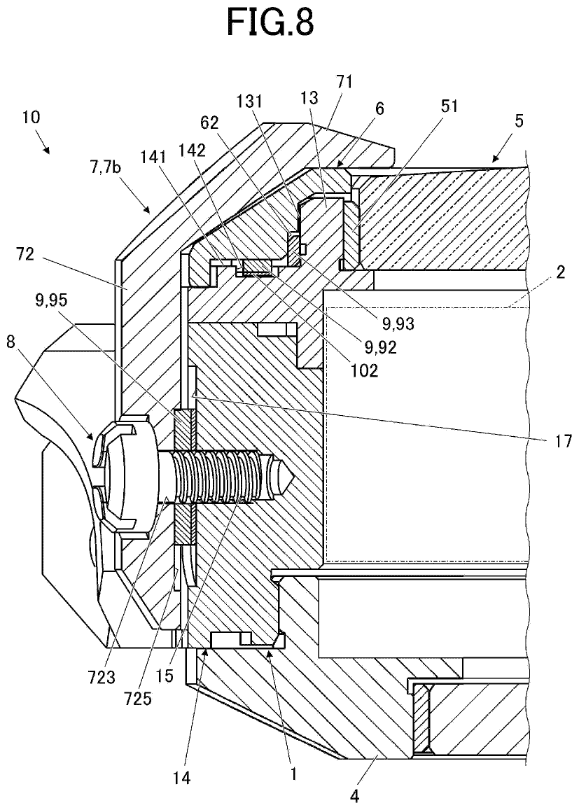

FIG. 7 is a schematic cross-sectional view along the VII-VII line in FIG. 1. FIG. 8 is a schematic cross-sectional view along the VIII-VIII line in FIG. 1.

As shown in FIGS. 4 to 8, a buffer 9 (second buffer 92), for example, formed in an approximately annular shape, is disposed between the case body 1 and the bezel 6 (in illustrated examples, between the upper end surface 141 of the cylindrical portion 14 and the bezel 6). The second buffer 92 is a second position buffer disposed to contact the upper surface of the case body 1. The second buffer 92 is formed of fluorinated rubber, for example. The material for forming the second buffer 92 is not limited to this.

The upper end surface 141 has a recess 142 in which the second buffer 92 can be fitted at the position where the second buffer 92 is disposed. When the second buffer 92 is disposed in the recess 142 and the bezel 6 is placed on top of it and fixed, the second buffer 92 is fixed between the upper end surface 141 of the cylindrical portion 14 and the bezel 6. The second buffer 92 may be flattened and pushed to spread within the recess 142.

The recess where the second buffer 92 is disposed is not limited to the case body 1 side (upper end surface 141 in the present embodiment). For example, a recess may be formed on the bezel 6 side, or a recess having thickness of half the second buffer 92 or less may be provided at corresponding positions of both the case body 1 and the bezel 6, and the second buffer 92 may be sandwiched within both recesses.

A buffer 9 (third buffer 93), for example, formed in an approximately annular shape, is disposed between the outer circumferential surface of the rising neck 13 (rising surface 131) and the bezel 6. The third buffer 93 is a second position buffer disposed to contact the side surface of the case body 1 when the bezel 6 and the case body 1 are radially fitted in the surface (side surface) in the thickness direction of the device case 10. Since the third buffer 93 is disposed along the rising surface 131, which is the surface in the thickness direction, it is required not only to have a cushioning effect but also not to cause twisting, and the like during assembling. Therefore, a certain degree of hardness, good slipping, and good fitting are required. From this perspective, fluorinated resin is suitably used as a material to form the third buffer 93. The material used to form the third buffer 93 is not limited to this. The third buffer 93 is formed by rounding off the inner lower corner on the rising neck 13 side of the case body 1 so that the third buffer 93 can be easily fitted. The outer upper corner on the bezel 6 (first exterior) side of the third buffer 93 is also rounded off.

A recess 62 is formed on the inner side surface of the bezel 6 corresponding to the placement position of the third buffer 93, into which the third buffer 93 can be fitted. When the third buffer 93 is disposed in the recess 62 and the bezel 6 is attached to the case body 1 in that state to be fixed, the third buffer 93 is flattened and pushed to spread in the recess 62.

The recess where the third buffer 93 is disposed is not limited to the bezel 6 side. For example, a recess may be formed on the rising surface 131 side of the rising neck 13, or a recess having thickness of half the third buffer 93 or less may be provided at corresponding positions of both the case body 1 and the bezel 6, and the third buffer 93 may be sandwiched within both recesses.

The rising surface 131 of the rising neck 13 and the upper end surface 141 of the cylindrical portion 14 are almost L-shaped in cross-section as described above, and the second buffer 92 disposed along the upper end surface 141 and the third buffer 93 disposed along the rising surface 131 may be connected in one piece that is almost L-shaped in cross-section.

The second buffer 92 and the third buffer 93 are not limited to those formed in an annular shape. For example, they may be buffers that are partially disposed along the circumferential direction of the case body 1. In this case, the second buffer 92 and the third buffer 93 may also be provided in the range corresponding to each other, and the second buffer 92 and the third buffer 93 may be connected in one piece that is almost L-shaped in cross-section.

Thus, when the second buffer 92 and the third buffer 93 are connected as a single buffer, it is preferable to use fluorinated resin, for example, for hardness and good sliding properties.

Furthermore, as shown in FIGS. 5 and 7, on the 3 o'clock side of the timepiece 100 where the first guard member 7a is provided in the present embodiment, the case body 1 has, as a second position buffer on the outer side surface of the case body 1 (cylindrical portion 14 of the case body 1), a fourth buffer 94, which is disposed between the case body 1 and the first guard member 7a (the side surface portion 72 of the first guard member 7a).

The fourth buffer 94 is formed of fluorinated rubber, for example.

In the present embodiment, recesses 16 are formed on the side surface on the 3 o'clock side of the case body 1 near the through holes 12 through which the shafts 31 of the operation receivers 3 are inserted (between adjacent through holes 12 in the illustrated example), and the fourth buffer 94 is disposed within each recess 16. As shown in FIG. 7, when the first guard member 7a is assembled to the case body 1, the recess 724 is also formed at a position corresponding to the fourth buffer 94. As a result, the fourth buffer 94 is interposed between the case body 1 and the first guard member 7a in a state where it is sandwiched between the recess 16 and the recess 724. The recesses for disposing the fourth buffer 94 are not limited to being provided in both the case body 1 and the first guard member 7a but may be provided only on the case body 1 side or only on the first guard member 7a.

As shown in FIGS. 6 and 8, on the 9 o'clock side of the timepiece 100 in which the second guard member 7b is provided in the present embodiment, a fifth buffer 95 is provided on the outer side surface of the case body 1 (cylindrical portion 14 of the case body 1) as a second position buffer and is disposed between the case body 1 and the second guard member 7b (side surface portion 72 of the second guard member 7b).

The fifth buffer 95 is formed of fluorinated rubber, for example.

In the present embodiment, screw holes 15 through which screws 8 are inserted are formed on the side surface on the 9 o'clock side of the case body 1 near the through holes 12 through which the shafts 31 of the operation receivers 3 are inserted (next to through holes 12 in the illustrated example). Around each of the screw holes 15 is a recess 17 that is one step lower than the other parts, and the fifth buffer 95 is disposed in this recess 17. As shown in FIG. 8, when the second guard member 7b is assembled to the case body 1, the recess 725 is also formed at a position corresponding to the fifth buffer 95. As a result, the fifth buffer 95 is interposed between the case body 1 and the second guard member 7b in a state where it is sandwiched between the recess 17 and the recess 725. The recesses for disposing the fifth buffer 95 are not limited to being provided in both the case body 1 and the second guard member 7b but may be provided only on the case body 1 side or only on the second guard member 7b.

The method of fixing each of these buffers 9 (the second buffer 92, third buffer 93, fourth buffer 94 and fifth buffer 95 as the second position buffer) is not particularly limited.

For example, similarly to the first buffer 91, the buffer 9 may be affixed and fixed to an object by means of double-sided tape 102 or an adhesive surface provided on the buffer 9 itself.

The buffers 9 (second position buffers) disposed at different positions from those of the first position buffers (first buffers 91) are not limited to those shown here. Also, the second position buffers may be disposed at various locations between the case body 1 and bezel 6, and between the case body 1 and guard member 7.

### [Actions]

Next, the device case 10 and the timepiece 100 including the device case 10 according to the present embodiment will be described in terms of its action.

When assembling the device case 10 of the present embodiment and the timepiece 100 including the device case 10, the module 2 is housed in the case body 1, and the opening on the visible side is closed with a wind shield member, and the opening on the non-visible side is closed with a back cover member. The bezel 6 as the first exterior is placed on the upper surface side (visible side) of the case body 1.

In addition, on at least part of the circumferential surface of the case body 1, guard members 7, each of which is a second exterior covering from the upper portion of the bezel 6 to the outer circumferential side surface of the case body 1, are disposed. In the present embodiment, the first guard member 7a is disposed on the 3 o'clock side in the timepiece, and the second guard member 7b is disposed on the 9 o'clock side. The guard members 7 are then fixed to the case body 1 to hold the bezel 6.

At that time, the first buffers 91 which are the first position buffers are disposed between the bezel 6 and the guard members 7 as the buffers 9.

Also, the second buffer 92 and third buffer 93 which are the second position buffers are disposed as buffers 9 as appropriate between the case body 1 and the bezel 6. Also, the fourth buffers 94 and fifth buffers 95 which are the second position buffers are placed as buffers 9 as appropriate between the case body 1 and the guard member 7.

Then, the operation receivers 3 such as pushbuttons or crowns are attached to the side of the case body 1, and the like from the outside of the guard members 7. For the second guard member 7b, which is provided on the 9 o'clock side in the present embodiment, the screws 8 are inserted into the screw holes 723 and screw holes 15 from the outside of the second guard member 7b and screwed to the side surface of the case body 1.

This completes the timepiece 100 with the device case 10 in the present embodiment.

In the device case 10 of the present embodiment, the case body 1, bezel 6, and guard member 7 are all formed of metallic materials. As a result, the timepiece 100 has a luxurious feel and an excellent external design.

In addition, buffers 9 are disposed at the portions where metal members contact or interfere with each other. Therefore, when the device case 10 and the timepiece 100 including the device case 10 are subjected to a shock due to dropping, and the like, the shock is absorbed by the buffers 9, so that the module 2, and the like housed inside the device case 10 are not affected.

That is, for example, when the timepiece 100 is dropped from the visible side, the impact is first absorbed by the first buffer 91 between the bezel 6 and the guard member 7, and then the second buffer 92 and third buffer 93 disposed between the bezel 6 and the case body 1 absorb the impact. Even when the timepiece 100 receives a shock from the side surface, for example, the shock is absorbed by the fourth buffer 94 and fifth buffer 95 disposed between the case body 1 and the guard member 7.

In this way, the configuration is made to absorb shocks in double or triple manners, effectively absorbing shocks from either the visible side or the side surface, thereby mitigating or reducing the impact on the module 2, including precision components, housed inside. This prevents damage to the case body 1 and the module 2 housed in the case body 1.

### [Effects]

As described above, the device case 10 in the present embodiment includes: a bezel 6, which is a first exterior placed on the upper surface side of the case body 1; guard members 7, each of which is a second exterior which, on at least part of the circumferential surface of the case body 1, covers from the upper portion of the bezel 6 to the outer circumferential side surface of the case body 1 and is fixed to the case body 1 to hold the bezel 6; and first buffers 91 (first position buffers) each of which is a buffer 9 disposed between the bezel 6 and the guard member 7.

Thus, by disposing the buffer 9 between members that contact and interfere with each other, external shocks can be effectively absorbed. This prevents the impact from affecting components such as the module 2 housed inside the case body 1, thereby avoiding damage to the components.

The case body, bezel 6, which is the first exterior, and the guard member 7, which is the second exterior, in the present embodiment are formed of metallic materials.

This gives the device case 10 a luxurious appearance.

Even when metal exteriors (bezel 6 as the first exterior and guard member 7 as the second exterior) are attached to the metal case body 1, the buffer 9 disposed between the metal members can absorb external shocks as in the case of resin exteriors and can protect the module 2 and other components housed inside the case body 1 from shocks.

It is also possible to prevent metal parts from directly interfering with each other, thus preventing parts from being damaged.

At least one of the bezel 6 as the first exterior and the guard member 7 as the second exterior of the present embodiment has a recess that houses at least part of the first buffer 91 (first position buffer).

As a result, the first buffer 91 fits within the recess and is less likely to shift position, and the like, when a shock is applied.

The recess also serves as a guide when assembling the first buffer 91. This makes the assembly work more efficient.

Even if the buffer 9 is disposed between the bezel 6 and the guard member 7, a gap between the bezel 6 and the guard member 7 can be prevented to achieve a good appearance.

Between the case body 1 and the bezel 6, which is the first exterior of the present embodiment, there are second position buffers (second buffer 92, third buffer 93) as buffers 9.

Thus, even between the case body 1 and bezel 6, it is possible to absorb shocks to reduce the impact on the interior of the case body 1.

The second position buffers (second buffer 92 and third buffer 93) in the present embodiment are disposed to contact at least one of the upper surface or side surface of the case body 1.

This allows the case body 1 to efficiently absorb shocks from the upper surface or side surface directions, which are the visible side of the case body 1, thereby improving shock resistance.

At least one of the case body 1 or the bezel 6, which is the first exterior of the present embodiment, has a recess that houses at least part of the second position buffers (second buffer 92, third buffer 93).

As a result, the second buffer 92 and the third buffer 93 fit within the recess and is less likely to shift position, and the like, when a shock is applied.

The recess also serves as a guide when assembling the second buffer 92 and the third buffer 93. This makes the assembly work more efficient.

Even if a buffer 9 is disposed between the bezel 6 and the case body 1, a gap between the bezel 6 and the case body 1 can be prevented to achieve a good appearance.

In the present embodiment, the first buffer 91 (first position buffer) and the second buffer 92 among the second position buffers are formed of fluorinated rubber, and the third buffer 93 among the second position buffers is formed of fluorinated resin.

The first buffer 91 and the second buffer 92 are made of fluorinated rubber, which is expected to have a high cushioning effect. On the other hand, the third buffer 93 is disposed along the rising surface 131, which is a surface in the thickness direction, so it is required not only to have a cushioning effect but also to prevent twisting and the like when assembling. Therefore, a certain degree of hardness, good slipping, and good fitting are required. From this perspective, fluorinated resin is suitably used as the material for forming the third buffer 93.

In the present embodiment, the third buffer 93 is formed by rounding off the lower corner on the case body 1 side and upper corner on the bezel 6 side which is the first exterior side, for easy fitting.

When the device case 10 of the present embodiment is applied to the timepiece 100, it is possible to achieve a shock-resistant structure.

### Modification Examples

Although the embodiments of the present disclosure have been described above, it goes without saying that the present disclosure is not limited to such embodiments and can be varied in various ways without departing from the gist thereof.

For example, the above embodiment has the first buffer 91 as a buffer 9 (first position buffer) between the bezel 6 and the guard member 7, and the second buffer 92, third buffer 93, fourth buffer 94 and fifth buffer 95 as buffers 9 (second position buffers) disposed at different positions from the first buffer 91. In the present embodiment, only the third buffer 93 is formed of fluorinated resin, and the other buffers 9 are formed of fluorinated rubber. However, the materials for forming the first position buffer (first buffer 91) and the second position buffers (second buffer 92, third buffer 93, fourth buffer 94 and fifth buffer 95) are not limited to this.

For example, the first position buffer (first buffer 91) and the second position buffers (second buffer 92, third buffer 93, fourth buffer 94, and fifth buffer 95) may be formed of materials having quality different from each other. For example, as for the rubber, acrylic rubber, nitrile rubber (for example, NBR; nitrile butadiene rubber), butyl rubber, silicone rubber, and the like may be used as appropriate depending on the location of disposing them. All of the first buffer 91 to fifth buffer 95 may be formed of the same material or may be formed of different materials. This allows appropriate materials to be applied according to the location of disposing the buffers, and the like.

Even if the same rubber is used, the hardness of the first position buffer (first buffer 91) and the second position buffers (second buffer 92, third buffer 93, fourth buffer 94, and fifth buffer 95) may be different from each other. For example, the buffer 9 disposed on the outside of the device case 10 may be made of a hard material with high hardness (for example, JIS hardness 90 degrees), and the buffer 9 disposed on the inside may be made of a soft material with low hardness (for example, JIS hardness 70 degrees).

The hardness of each buffer 9 is not limited to this. Contrary to the above, a hard material with high hardness may be used for the buffer 9 disposed inside the device case 10, and a soft material with low hardness may be used for the buffer 9 disposed outside.

As the hardness is higher and the material is harder, the repulsive force is greater. As the hardness is lower and the material is softer, the repulsive force is smaller. Therefore, by selectively using and combining materials of different hardness as appropriate for the location where each buffer 9 is disposed, the overall cushioning performance can be expected to be enhanced.

Furthermore, even if the same rubber is used, the thickness of the first position buffer (first buffer 91) and the second position buffers (second buffer 92, third buffer 93, fourth buffer 94, and fifth buffer 95) may be different from each other.

For example, thick buffers 9 are applied in areas where space is available to dispose thick buffers 9, and thin buffers 9 are placed in areas where only thin buffers 9 can be disposed.

The thickness, hardness, quality and the like of the material forming the buffer 9 in each section may be combined so that the cushioning effect can be enhanced more effectively according to the disposing space and the like.

In the present embodiment, protrusions 90 may be formed on at least part (for example, on the front surface or back surface) of each buffer 9 (that is, the first buffer 91, second buffer 92, third buffer 93, fourth buffer 94, and fifth buffer 95).

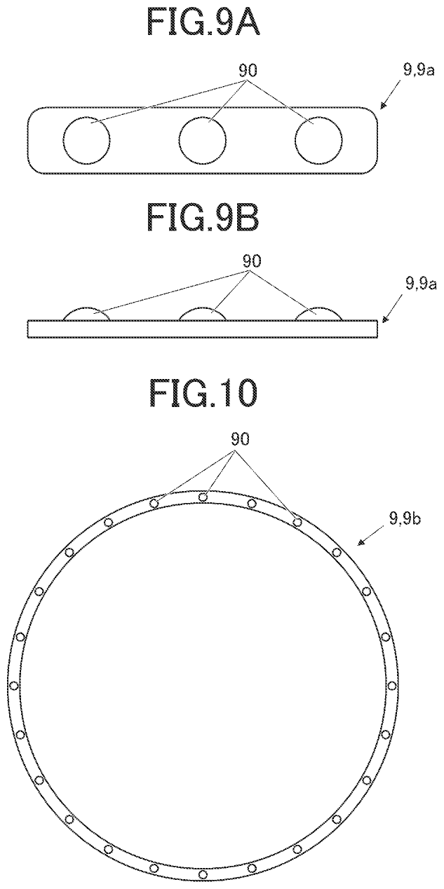

FIGS. 9A and 9B show an example of protrusions 90 on the front surface of a buffer 9 (buffer 9a) partially arranged, for example, as in the first buffer 91, fourth buffer 94, and fifth buffer 95 in the present embodiment. FIG. 9A is a top view of the front surface of the buffer 9a, and FIG. 9B is a side view of the buffer 9a shown in FIG. 9A.

FIG. 10 also shows an example of protrusions 90 on the surface of a buffer 9 (buffer 9b) formed in an annular shape, for example, as in the second buffer 92 and third buffer 93 in the present embodiment.

In FIGS. 9A, 9B and 10, the case in which the protrusions 90 are provided on the front surface of the buffer 9 is illustrated, but protrusions may be provided on the back surface of the buffer 9. The protrusions 90 may also be provided on the front and back surfaces of the buffer 9.

The height of protrusions 90 and the number (density) of protrusions 90 relative to the surface are not limited. The size, height, and the like of the protrusions 90 may be adjusted depending on the quality, hardness, thickness, and the like of the material forming the buffer 9.

Thus, by providing the protrusions 90 on the buffer 9, the buffer 9 can make point contact between the parts that interpose the buffer 9. This allows for a higher cushioning effect and is expected to effectively absorb external shocks.

For example, in the above embodiment, the device case 10 is applied to the timepiece 100, but the device case 10 is not limited to a timepiece case.

The device case 10 of the present embodiment may be widely applied to cases for devices that house, inside the case body 1, components which may be damaged due to impact.

For example, the device case 10 of the present embodiment can be applied to various types of electronic devices such as smartwatches, sports watches, and other wearable devices that acquire biometric information such as heart rate and blood flow information as well as time.

Though several embodiments of the present disclosure have been described above, the specific configuration, structure, positional relationships, and the like shown in the above embodiments can be modified as appropriate in the range not departing from the gist of the present disclosure. The scope of the present disclosure includes the scope of inventions, which is described in the scope of claims, and the scope equivalent thereof.

1. A device case comprising:
a first exterior that is placed on an upper surface side of a case body;
a second exterior that covers at least an upper portion of the first exterior; and
a first position buffer as a buffer disposed between the first exterior and the second exterior, wherein
the first exterior includes an inclined surface on an upper surface side, and
the first position buffer is disposed on the inclined surface of the first exterior.

2. The device case according to claim 1, wherein, on at least part of a circumferential surface of the case body, the second exterior covers from the upper portion of the first exterior to an outer circumferential side surface of the case body and is fixed to the case body.

3. The device case according to claim 1, wherein the case body, the first exterior, and the second exterior are formed of a metallic material.

4. The device case according to claim 1, wherein a recess that houses at least part of the first position buffer is formed in at least one of the first exterior or the second exterior.

5. The device case according to claim 1, further comprising a second position buffer as a buffer between the case body and the first exterior.

6. The device case according to claim 5, wherein
the second position buffer includes:
a second buffer that is disposed to contact an upper surface of the case body; and
a third buffer that is disposed to contact a side surface of the case body, and
the second buffer and the third buffer are disposed apart from each other.

7. The device case according to claim 6, wherein the second buffer and the third buffer have hardness different from each other and/or are formed of materials having quality different from each other.

8. The device case according to claim 5, wherein a recess that houses at least part of the second position buffer is formed in at least one of the case body or the first exterior.

9. The device case according to claim 1, whereon at least part of a buffer is formed with a protrusion.

10. The device case according to claim 1, wherein, when the device case includes, as the buffer, a first position buffer and a second position buffer that are disposed at positions different from each other, the first position buffer and the second position buffer have hardness different from each other.

11. The device case according to claim 1, wherein, when the device case includes, as the buffer, a first position buffer and a second position buffer that are disposed at positions different from each other, the first position buffer and the second position buffer are formed of materials having quality different from each other.

12. The device case according to claim 6, wherein
the first position buffer and the second buffer are formed of fluorinated rubber, and
the third buffer is formed of fluorinated resin.

13. The device case according to claim 12, wherein a lower corner on a case body side and an upper corner on a first exterior side of the third buffer are rounded off.

14. The device case according to claim 1, wherein, when the device case includes, as the buffer, a first position buffer and a second position buffer that are disposed at positions different from each other, the first position buffer and the second position buffer have thickness different from each other.

15. The device case according to claim 1, further comprising a second position buffer as a buffer between the case body and the second exterior.

16. A timepiece comprising the device case according to claim 1.

17. A device case comprising:
a first exterior that is placed on an upper surface side of a case body;
a second exterior that covers at least an upper portion of the first exterior;
a first position buffer as a buffer disposed between the first exterior and the second exterior; and
a second position buffer as a buffer disposed between the case body and the second exterior.

18. The device case according to claim 17, wherein, on at least part of a circumferential surface of the case body, the second exterior covers from the upper portion of the first exterior to an outer circumferential side surface of the case body and is fixed to the case body.

19. The device case according to claim 17, wherein the case body, the first exterior, and the second exterior are formed of a metallic material.

20. A timepiece comprising the device case according to claim 17.
